(19) United States
(12) Patent Application Publication
(10) Pub. No.: US 2021/0374885 A1
(43) Pub. Date: Dec. 2, 2021

(54) RESTAURANT ON-DEMAND LOCATION AND ORDER MANAGEMENT SYSTEM

(71) Applicant: The Kitchen Cafe, LLC, Boulder, CO (US)

(72) Inventors: Kimbal Musk, Boulder, CO (US); Donald Degnan, Boulder, CO (US)

(21) Appl. No.: 17/336,210

(22) Filed: Jun. 1, 2021

Related U.S. Application Data
(60) Provisional application No. 63/031,797, filed on May 29, 2020.

(51) Int. Cl. G06Q 50/12; G06Q 20/20

(52) U.S. Cl. CPC G06Q 50/12; G06Q 20/20

(57) ABSTRACT

Methods, systems, and devices are described for dine-in location and on-demand order management through a customer mobile device. The customer may access a menu of available options, select one or more items, and place an order. Further, the customer may enter or otherwise provide a location identification when placing the order, which may allow a server or runner to deliver the order to the proper location (e.g., a table or other identified location within a dining area). Upon order placement, a confirmation may be provided that may include an estimated time for delivery of ordered items. Payment may be processed through the customer mobile device after delivery of the ordered items.

### CROSS-REFERENCE TO RELATED APPLICATIONS

This application claims priority to U.S. Provisional Patent Application Ser. No. 63/031,797, filed on May 29, 2020, and entitled RESTAURANT ON-DEMAND DINE-IN LOCATION AND ORDER MANAGEMENT SYSTEM; the entire disclosure of which is incorporated by reference herein.

### BACKGROUND

The present invention relates to electronic ordering systems in general and, in particular, to a system that provides a customer location within or relative to an establishment along with order information.

Dine-in restaurants commonly have a dining room, dining area, patio, bar, and/or other location (referred to generally as a “dining area” herein) where customers may be seated for a food service, drinks, or both. A customer may be seated in the dining area (e.g., by a host or matre d', self-seating, etc.) and review a physical menu such as a paper menu, a menu board, and the like. The customer may make one or more selections, and a server may take the customer's order. The server may relay the order to a kitchen or service area by physically providing a ticket or entering order information into an electronic order system. Once the order is ready, it may be delivered to the customer by the server or other staff. Once the customer has completed their meal, drinks, or both, the server may provide a check that may then be paid by the customer. Such traditional restaurant procedures may have several areas of inefficiencies, such as a wait time to place an order or to receive a check, for example. Further, physical menus may also introduce some inefficiencies, as such menus may be out of date or unclean. Thus, systems are desirable that reduce such inefficiencies and thus may enhance the customer experience and increase restaurant efficiency/profitability.

### SUMMARY

Methods, systems, and devices are described for dine-in location and on-demand order management through a customer mobile device. In some cases, a customer may load an application onto the mobile device (e.g., mobile phone, wearable device, tablet computer, etc.), or access a web interface (e.g., via a website address) from the mobile device. Either the application on the mobile device or the web interface provides, at the mobile device, a user interface at which the customer can view a menu of available options, select one or more items, and place an order. Further, the customer may enter or otherwise provide a location identification when placing the order, which may allow a server or runner to deliver the order to the proper location (e.g., a table or other identified location within a dining area). In some cases, a table number may be marked on each table (or other location) in the dining area, and the customer may enter this number into the user interface when placing the order. In other cases, each table or other location in the dining area may have a unique optical or electronic marker (e.g., a near-field RF device, an optical QR code, or other image) that the customer may scan, thus avoiding potential errors in table number entry.

In some cases, the customer may register with the application and provide credentials that may allow for age verification of the user and automatic electronic payment once the order has been placed or once the order has been confirmed to have been delivered to the customer. Once placed, the order may be provided to restaurant staff for processing, production, and delivery.

Such a system may provide a number of advantages or benefits. For example, the customer may directly enter order information at their own pace, and may take as little or as much time as desired. Thus, wait times associated with a server to come take an order may be reduced. Additionally or alternatively, a customer may receive descriptions of dishes or recommendations from a server, and may take time to consider their order without the pressure of a server waiting for them to decide. Further, systems provided herein allow for a customer to provide a tip and close out a tab without having to wait for a check, provide payment to a server, and wait for the server to process the payment. Thus, substantial wait times may be reduced, which may enhance customer experience and also allow the restaurant to turn tables more quickly and thereby increase profitability. Moreover, techniques discussed herein allow for reduction or elimination of a physical menu or device that is provided to the customer for selecting items to order. As discussed herein, such physical menus may carry contamination (e.g., bacteria, viruses, etc.) and use of the customer's personal electronic device for ordering provides enhanced sanitation. Moreover, techniques as discussed herein may allow faster communication of orders to staff (e.g., cooks, bartenders, etc.) which may increase efficient, allow servers to more efficiently serve more customers, which may enhance food and beverage efficiency and enhance customer experience.

### BRIEF DESCRIPTION OF THE DRAWINGS

FIG. 1 illustrates a restaurant layout with tables that may use a location and order management system in accordance with aspects of the present disclosure.

FIG. 2 illustrates a block diagram of a system including components configured in accordance with aspects of the present disclosure.

FIG. 3 illustrates a block diagram of a location and order management device in accordance with aspects of the present disclosure.

FIGS. 4-7 illustrates table identification and exemplary screen captures of a user interface at a mobile device.

FIGS. 8-9 illustrate flow charts for location and order management in accordance with various aspects of the present disclosure.

### DETAILED DESCRIPTION

As discussed above, dine-in restaurants or other food service establishments generally have a dining area where customers may be seated for a food service, drinks, or both. A customer may be seated in the dining area, and interact with a server to have an order placed and delivered to the table, as well as to receive a check and handle associated payment. Various aspects of the present disclosure provide for electronic entry of order information by a customer or user, using an application that is loaded onto the customer's mobile device a web interface accessed by the customer's mobile device, or combinations thereof. While various examples discussed herein use a restaurant or bar as an example, techniques provided herein may be used in any of a number of settings where a user location may be used to identify available items or services that may be provided to a user, and to assist in delivery of items or service to the user.

As discussed herein, physical menus may also introduce inefficiencies in food service establishments. For example, menu changes may commonly occur due to a supply of fresh ingredients available to the restaurant, certain dishes being sold out, changing special dishes, and the like. Due to such changes, restaurants may have to re-print menus on a relatively frequent basis, a server may have to explain certain dishes that are no longer available or describe off-menu items, and/or a server may have to return to a table after an order has been placed due to a discovery that an ordered item is sold out. Additionally, physical menus may carry contaminants between different customers and are often not cleaned or sanitized between uses. If such physical menus are cleaned/sanitized between uses, this can add an additional burden to restaurant staff, and may be a step that has a high likelihood of being skipped. The electronic ordering system and methods as discussed herein thus have additional benefits and advantages of eliminating or substantially reducing use of such physical menus or other physical device that may be provided by the restaurant to the customer for purposes of selecting items to order.

Various aspects of the disclosure provide a food ordering system that may include a number of components. For example, such a system may include an application and/or web server (referred to generally as an “application server” herein) that interacts with the customer mobile device to receive order information and a physical location identifier of the customer within the dining area. The order information may be received through selections from a menu that is displayed to the customer on their mobile device, and may include one or more items to be delivered to the customer at the physical location within the dining area. An order management system may be coupled with the application server and configured to receive order information and the physical location identifier. The order management system may provide this information to kitchen and restaurant staff for production of the one or more items of the order and delivery to the customer at the identified physical location. A payment component may also be coupled with the order management system and the application server and configured to electronically process payment for the one or more items delivered to the user. In some cases, the customer may register the application, or log into the web interface, and provide electronic payment information such that, upon verification of customer credentials, payment may be processed for the one or more items ordered by the customer.

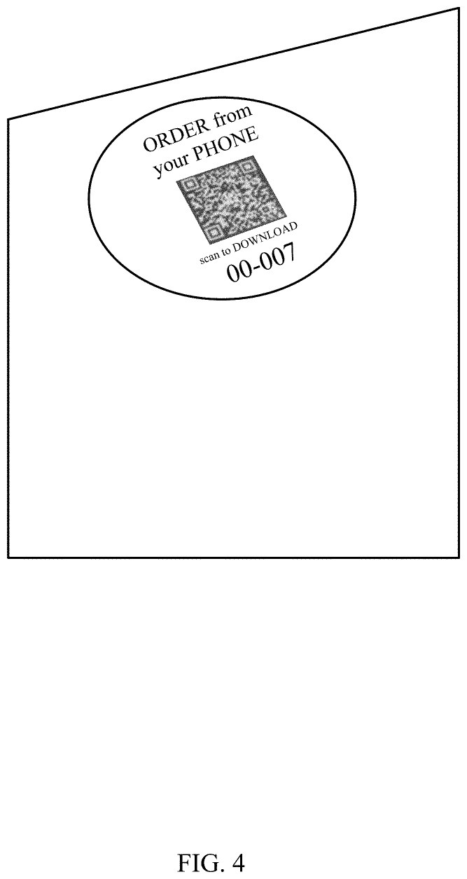

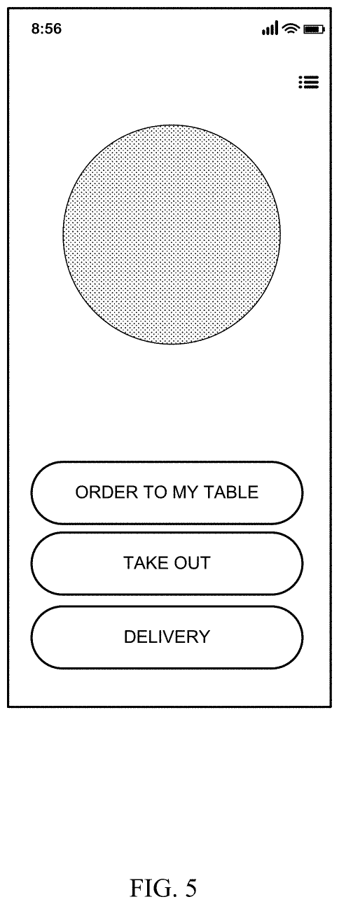

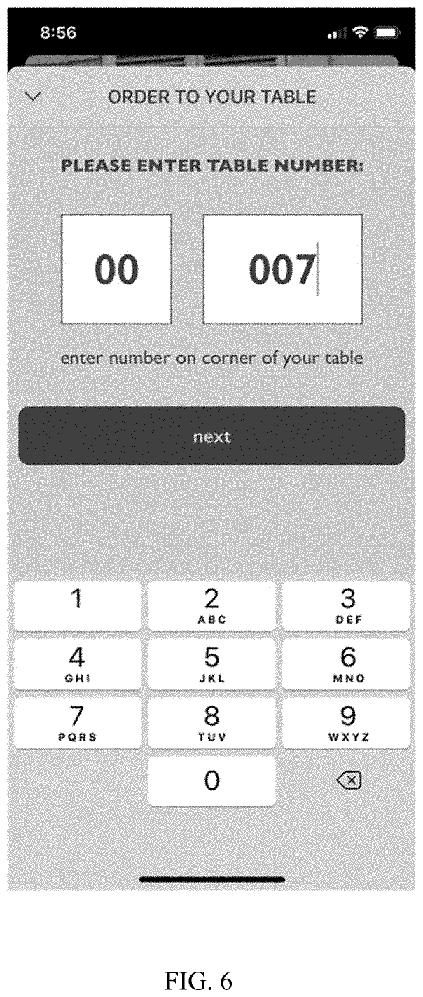

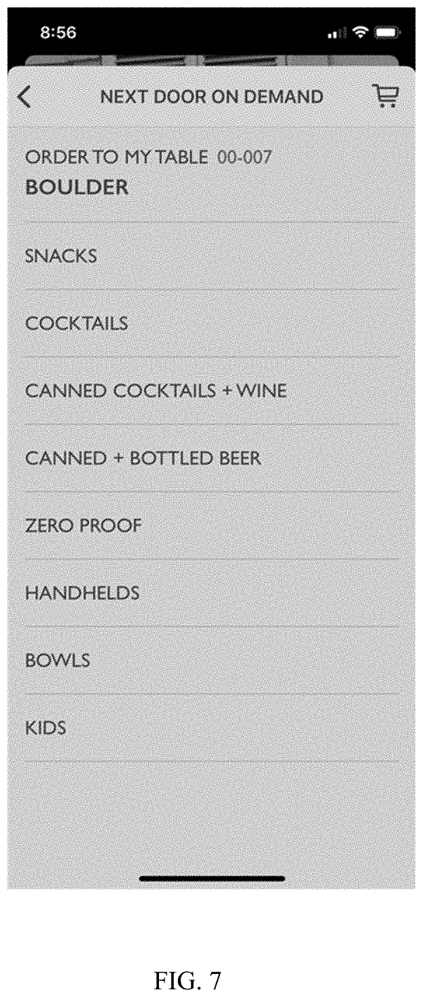

In some cases, the physical location identifier comprises one or more of a table number that is marked on a table and entered into the application by the user (e.g., a table number etched into the table, printed and placed at the table, adhered to the table, etc.), an identification from an optical marker on the table that is scanned into the application (e.g., a QR code or other optical code, a unique optical image that is mapped to the physical location in the dining area, and the like), an electronic identification based on an electronic marker on the table that is scanned into the application (e.g., a near-field RF marker that provides a table or physical location identifier), or any combinations thereof. In some cases, the table number or identification may provide both a restaurant site and a physical location within the restaurant, such is illustrated in FIG. 4, in which a first set of digits of the table number indicate the particular restaurant (e.g., 00=Boulder Colo., 01=Denver Union Station, etc.), followed by a second set of digits that indicates the table within the restaurant (e.g., table 000, which has a known location within the dining area). Such an identification allows for unambiguous identification of the restaurant and table location within the dining area of the restaurant. Further, in this example, an optical code is present at the table that may be scanned at the mobile device to direct the customer to a store at which an application may be downloaded, or that may direct the customer to a web URL to access the web interface. FIGS. 5 through 7 provide screen captures of an example of user interface pages at a customer's mobile device.

In some cases, the order management system may provide a Back Of House display for the host of the restaurant. Such a display, or dashboard, may provide real time updates of when any tables orders anything. That display may be used for a number of management functions such as, for example, to manage checking for ID's, sharing status of the order with the guest, and general guest management. Further, information on the order may be provided to one or multiple individuals upon entry by the user, such as to a server responsible for the user, a line chef that may prepare a food order, a bartender that may prepare a drink order, and the like. Such on-demand menu access and ordering, along with tab payment, may substantially enhance the efficiency at a restaurant or other establishment that may implement techniques as described herein. For example, by providing order information directly from the customer to a line chef, latency associated with obtaining the order and entry of the order may be reduced, thereby reducing the amount of time between order selection and food delivery. Such enhanced efficiency may allow a server to serve more tables and customers more quickly, and also allow for a higher rate of table turn-around between consecutive parties, both of which may combine to lead to enhanced income for the server through additional tips, enhanced revenue for the restaurant, and enhanced income for back-of-house personnel (e.g., bussers/runners/chefs/etc.) when tip sharing is used, among other advantages.

In some cases, the order management system is further configured to perform metering of received orders based on a rate of production of a kitchen or service area, and in some cases may provide a time estimate to the customer for delivery of the one or more ordered items based at least in part on the identified rate of production. In some cases, the rate of production may be determined based on one or more inputs, such as a combination of historical production times, time of day, day of week, staff present for production (e.g., number of staff, particular individuals present, or combinations thereof), available equipment for preparing orders (e.g., if an oven or grill is non-functional a production rate may be decreased), and the like. In some cases, machine learning algorithms may be used to perform and refine such metering and time estimations based on historical data for preparing orders.

In some cases, the application server may also provide menu information to the application or via the web interface, wherein the menu information is determined based at least in part on one or more of a list of available items, a restaurant site of the physical location (e.g., different sites of a chain of restaurants), a time of day, an age of the user, or any combinations thereof. In some cases, additionally or alternatively, the menu information may be determined based on allergen information of the user (e.g., based on allergen information provided by the user when the user registers the application or updated subsequent to registration). In some cases, if a restaurant has a number of different sites, the physical location information may also provide an indication of the particular site at which the customer is located (e.g., city/state/neighborhood/restaurant number, etc.).

In some cases, once the timing of the order is calculated and updated (e.g., based on how busy the kitchen is, based on number of orders, etc.), a notification may be sent to the mobile device or wearable device of the server or food/drink runner responsible for that table, so they can check in with the table and provide a personal update, in addition to something being sent to the customer who ordered (e.g., a push notification to the user's mobile device or a notice on the application at the user's mobile device). Similarly, when the food has been prepared by the kitchen, a notification may be pushed to the server/runner responsible for that table to pick up and deliver the food/drink. Additionally, in some cases, upon entry of an order (e.g., a drink order), a ‘next round’ notification or text may be provided to the customer that includes a link that allows the customer to simply tap the link to place the same order again without having to go through separate steps of launching the app, selecting the menu item(s), authorizing payment, etc.

In some cases, the application or web interface accessed via the customer's mobile device may be used for in-restaurant ordering, delivery orders, and pick-up orders. In such cases, an initial entry may provide a location of the restaurant, followed by an indication of whether the order is for in-restaurant, deliver, or pick-up. In the event that the order is for in-restaurant, the customer may be prompted to enter the physical location identifier (e.g., by manual entry, optical or electronic scan, etc.), which may allow restaurant staff to deliver the order to the customer. The application may provide a menu that may be based on whether the order is for in-restaurant, delivery, or pick-up. For example, the menu for in-restaurant dining may be longer and include alcoholic beverages, and may also change between day and night. Similarly, the menu for delivery and to-go may be shorter, may or may not include alcoholic beverages, and may not change based on time of day.

In some cases, the in-restaurant dining order entry may allow a customer to provide payment as items are delivered, may provide a ‘Recommended Tip’ choice (e.g., 15-20-25%), or combinations thereof. For payment options, the application may provide options to ‘Pay Restaurant Directly,’ to ‘Keep Your Tab Open,’ or ‘pay tab.’ In some cases, the application may enable location services, and payment may be processed when the customer leaves a predetermined proximity of the restaurant. In some cases, the application may provide a ‘add your phone number’ option in case the customer needs to be found in the restaurant.

In some cases, if no tables are immediately available for the customer, the customer may be added to a waiting list for a table, and an in-restaurant dining order may be provided while the customer is waiting. In some cases, the order management system may provide the order to the kitchen or service area for production based on an estimated time that a table will be available for the customer and an estimated time for producing the order. Such techniques may allow the customer to be provided with the ordered item(s) relatively quickly after being seated, which may help to increase table turn-over and decrease wait time for the customer. In some cases, the estimated time that the table will be available and the estimated time for producing the order may be based on historical times that are logged at the order management system. In some cases, a number of factors may be included when determining such estimated times, such as a time of day, day of the week, special events or holidays (e.g., if it is on or around a holiday, if a sporting event or festival is scheduled, etc., which may result in parties occupying tables for longer or shorter periods of time), activities or promotions of the restaurant (e.g., trivia or game night, school or charity fundraising is scheduled, etc.), or any combinations thereof. In some cases, historical data for the various different factors may be logged at the order management system and analytics used to generate models for estimated times. In some cases, machine learning algorithms may be used to perform and refine such time estimations.

In cases where the customer selects the Pick-Up option, the ordering process remains the same, with potential different options for menu selections and a requested pick-up time. In cases where the customer selects delivery, the customer may be prompted to enter a physical address for the delivery. In some cases, a delivery request may be forwarded to a delivery service that may collect the order at the restaurant and deliver it to the customer.

In some cases, techniques as discussed herein may be implemented at a larger site (e.g., a concert/festival venue or stadium), a campus (e.g., a corporate campus), or a property (e.g., a resort property that spans a relatively large area of land), and user location may be used to determine one or more of a delivery location for items or services requested by the user, a list of available items or services, or both. For example, based on a location, a user may be provided with two (or more) food/beverage options (e.g., food/beverage stands in relatively close proximity to the user), and may select one of the options (e.g., a beverage stand) and may be provided a menu of items for the selected option (e.g., a list of available beverages from which a selection may be made). After selection of an item (e.g., a menu item) and payment, the selected provider may deliver the item to the user based on the user's location. In other cases, the selected provider may prepare the user's order and the user may pick up the order (e.g., from a food stand at a concert or stadium) when a notification is received that the order is ready. Such techniques may allow for efficient ordering from food/beverage providers in proximity to users without the users having to wait in long lines to order/receive food or beverage. In some cases, the app may provide an order ID or QR code that may be provided in order to pick up an order (and in some cases prompt the serving food/beverage location to confirm ID/age of the user). Similarly, in such cases, a server may bring orders to the user based on the user location. As discussed herein, the user location may obtained using one or more of a number of available techniques, such as entered by the user (e.g., based on a location code at a table or location of the user), scanned optically (e.g., a QR code) or electronically (e.g., a near-field RFID device), or provided by a positioning system of the user device (e.g., global positioning system (GPS) coordinates), to name a few examples.

Additionally, in some cases, an operator of multiple food/beverage locations may offer certain incentives or rewards to users who select a particular food/beverage location. For example, if a resort has two different pool areas and one of the areas is being underutilized, a user may be provided with an incentive to use the underutilized area, such as by offering a discount or order credit for orders at a particular food/beverage location. Such techniques may allow an operator to attempt to steer customers to locations that may be less crowded and better able to serve customers. In other cases, the operator may reassign staff to a busier location based on a quantity of orders at different locations, and in some cases an application server may perform real-time monitoring and either adjust staffing or recommend staffing adjustments to the operator. Further, similar techniques may be used by providers that are in proximity to a user's location. For example, a user may launch the app and thereby opt-in to sharing their location, and providers within a vicinity of the user may provide one or more offers to the user for items/services. For example, a user at a boardwalk at a beach may opt-in to location sharing, and food/beverage providers, or other providers (e.g., clothing or beach gear providers), in proximity to the user may be displayed. The user may select a provider to look at available items and place an order as discussed herein, that the user may pick up or that may be delivered to the user. Such techniques may be used, as discussed, at relatively large venues, in certain areas of a city or community (e.g., an area associated with a downtown having a concentration of food/beverage providers), at resorts, at festivals, on corporate campuses (e.g., employees may order food/beverage from providers on a corporate campus or in proximity to the corporate campus, or company hosts may order items for a meeting using a corporate account for payment), and the like.

Additionally, or alternatively, techniques discussed herein may be used by provider (e.g., restaurant) to provide incentives or rewards to a user. In some cases, the application server (or an order management function) may identify that the user ordered a particular item, and the user may then be provided with a coupon or credit that may be used on a similar item. For example, if a user orders a cheeseburger, the application server may identify that the user may also enjoy a grilled chicken sandwich, and provide a coupon or credit to the user if they purchase the grilled chicken sandwich. Such techniques may expand the number of items that the user enjoys from the provider which may in turn increase the likelihood of a user visit. In some cases, if a user frequently visits or orders from the establishment, enhanced rewards or incentives may be provided, and in cases of the most frequent users an owner, manager, or concierge may be notified of the user's presence and may personally greet and thank the user.

Further, in some cases, the application server may maintain user history that may be used for enhanced personalization and recommendations for the user (e.g., if the user opts-in to allowing such collection). In some cases, analytics may be performed on the user history to provide enhanced recommendations or personalization (e.g., credits or discounts on food/beverage based on the user's historical days/times of visits, which may incentivize the user to select the provider that offers such rewards). Further, if particular days/times become capacity constrained at an establishment, the application server may identify a user tendency to visit at those days/times, and may provide incentives for a different day or time, to attempt to ease congestion and provide a more enjoyable user experience. In some cases, analytics may be used to identify one or more groups of people that may tend to visit an establishment together, and such incentives/rewards may be provided to members of the groups such that they may be more likely to visit at a less congested time. In some cases, machine learning algorithms may be used to identify users and sizes of incentives, which may use feedback to refine identification and incentive size. For example, multiple different users may be provided with multiple different value coupon credits (e.g., a $1/$2/$4 credit, etc.), and redemptions of the credits may be used to identify and refine incentive amounts for one or more different user parameters (e.g., age or demographic information, other users that are commonly in a same group, items ordered, etc.).

In some cases, the reward or status incentives may be used to provide a guest with a link they can share with friends. If a friend uses the link then the original guest gets a reward (e.g., a free appetizer or drink). Further, a customer may gain status through multiple levels of referrals, frequency of visits, amount of spent, and the like. For example, if a customer forwards a link with a certain number of friends and a certain number of the friends register and visit the restaurant, the customer may get a more substantial reward. Such status levels may result in discounts, access to special events, special seating, and/or any of a number of incentives that may increase based on the customer's status level.

Additionally or alternatively, the application server may provide the ability for a number of customers to join a group (e.g., based on a number of people at a same table, or linked friends that are registered with the application server). In some cases, games may be provided to each member of the group (e.g., trivia, timed games, object identification games, etc.), and a winner of the game may have their tab paid for by other members of the group, or a loser of the game may pay the tab for all group members, by a round of drinks or an appetizer, and the like. In some cases such games may be provided at times or one or more members of the group may not be present at the restaurant, and users may receive credits or rewards for future use at the restaurant.

Additionally, in some cases, a customer may pre-order dine-in using the user interface. For example, a user may make an order as they leave the office or other workplace and start walking/driving over to the restaurant. The application server in such cases may assign a table or bar seat to the guest based on preference and number of guests in the party. When they arrive, they are escorted to their seat and their food and/or drink may immediately delivered or delivered relatively quickly.

Further, in some cases, a feature may allow each individual in a party select what they want, but the selections are automatically sent to a designated phone in the group (e.g., using an “It's on me function”) before the order is placed. For example, one family member may register at a table as a designated user that receives orders from other users and approves the addition of the orders, and pays for all of the approved orders. Such a technique may eliminate the passing of the mobile device to place family orders or having one individual collect the orders and input into their device. Additionally, in some cases, a group of customers in a party (e.g. based on table location, linked friends, etc.) may place all orders in a single tab that is to be paid by a single member of the group. In some cases, the paying member may be selected just prior to payment. In some cases, if multiple group members want to pay, a random number generator may select one member to pay (e.g., a roulette type wheel may be shown on the display, and land on the selected group member that is to pay), or two or more members may split the payment, etc. In some cases, a designated user may grant others access to the group, and orders by group members may be added to the total group order and group tab, with payment options provided to group members as discussed herein.

Additionally, in some cases, a feature may be provided in the user interface that provides the ability to allow the guest to set the time for a round of drinks, or to course dining experience. For example, a customer may set a request to deliver three drinks, one every 20 minutes. In some cases, for a longer, coursed experience, the guest may order appetizers and an initial round to come out immediately, and the main course and next round of drinks may come out 15 minutes afterward, and the like.

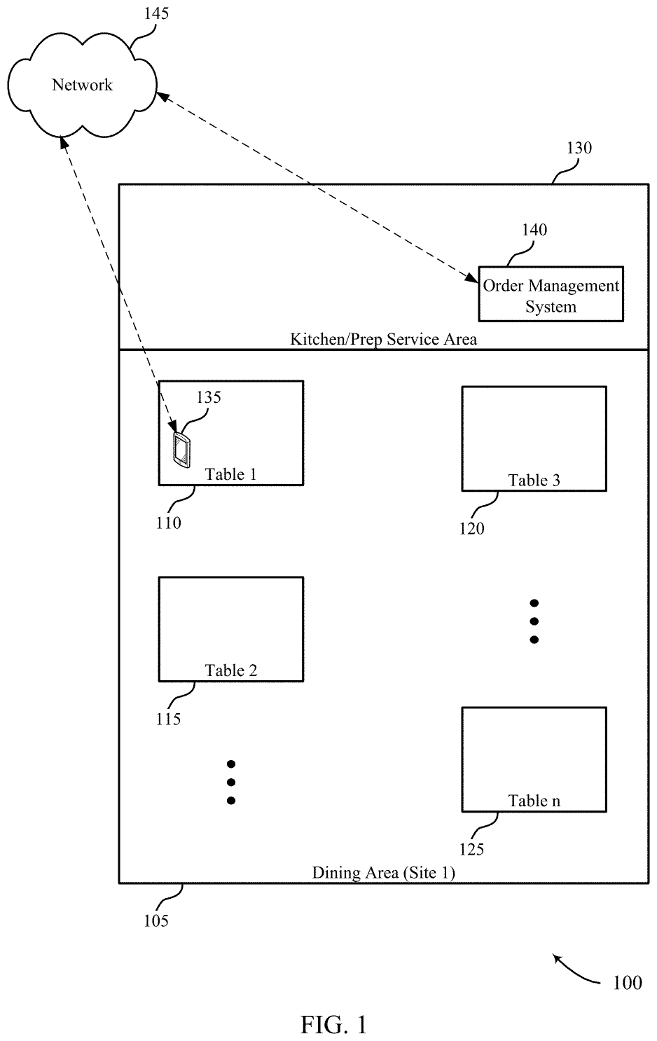

FIG. 1 illustrates an example of a restaurant dine-in location and order management system 100 in accordance with various aspects of the present disclosure. In this example, a dining area 105 may have a number of tables 110 through 125. In some cases, each table may have a table identification affixed that is affixed thereto. As discussed herein, such an identification may be a table number of other numerical or text-based identification, an optical identification such as a scannable code or image, an electronic identification such as a near-field RF tag, and the like. A customer may use a mobile device 135 to enter the table identification and optionally the site location of the restaurant through the user interface. The user interface may provide a menu to the customer, which the customer may use to select one or more items for delivery. The order information and physical location of the customer (e.g., table identification and optionally restaurant site location) may be provided to an application server via network 145. The application server may provide order information to an order management system 140 that is located in a kitchen or preparation service area 130 of the restaurant.

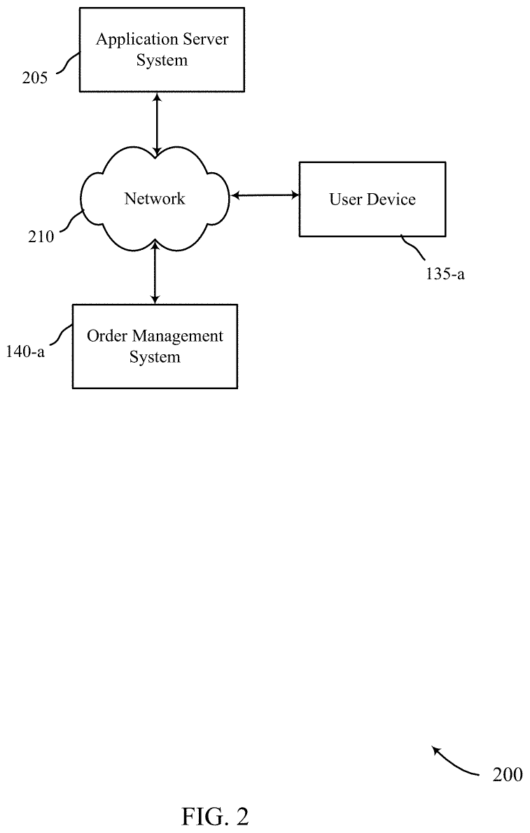

FIG. 2 illustrates a generalized block diagram of a restaurant dine-in location and order management system 200 in accordance with various aspects of the present disclosure. The restaurant dine-in location and order management system 200 includes an application server system 205, a user device 135-a, and an order management system 140-a, which may all communicate via a network 210. The network 210 may be any communications network, such as the Internet, a local or wide area network, a wireless communications network, and the like. In some cases, each of the components of the restaurant dine-in location and order management system 200 may be at a same location, or one or more components may be located remotely from other components. Further, one of more of the application server system 205 or order management system 140-a may be cloud hosted.

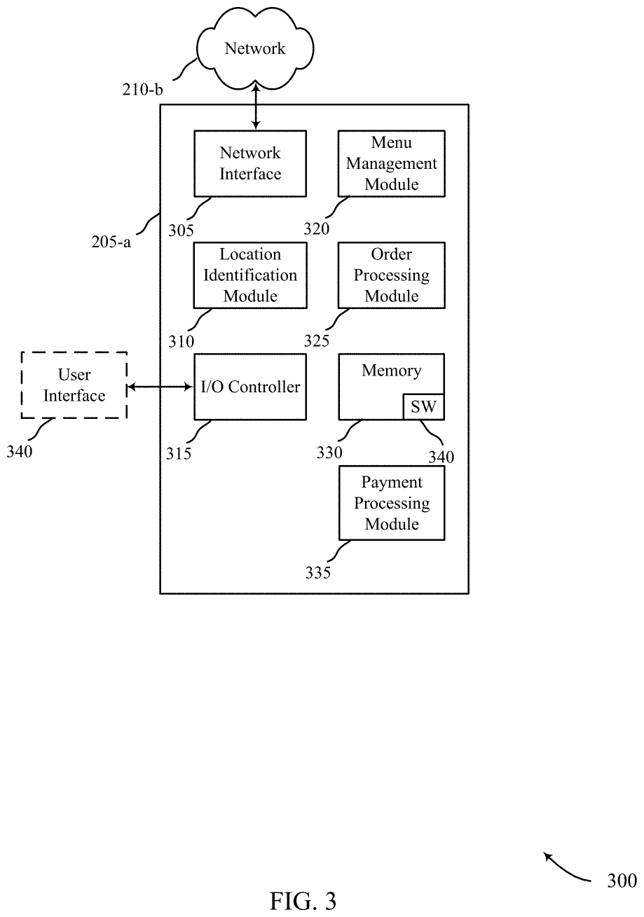

FIG. 3 shows a block diagram 300 of an application server 205-a of one example. In this example, the application server 205-a may be coupled with network 210-b (e.g., the Internet), and may have a network interface 305 that manages communications with the network 210-b. A location identification module 310 may receive physical location information from the customer, as discussed herein, which may include an indication of a particular restaurant and a physical location within the restaurant, for example. In some cases, the location identification module 310 may include a table of identifications that may be used to indicate to the order management system a table of the customer. An I/O controller 315 may perform input/output functions of the application server, including communications with an optional user interface 340 (e.g., a remote management interface or administrator interface). A menu management module 320 may provide menu information to the application based on the restaurant location, time of day, available menu items, etc. An order processing module 325 may receive orders from the application and manage the orders to provide information to an appropriate order management system of a kitchen, for example. A memory 330 may include software 340 used to execute instructions to provide functions of the application server as discussed herein. Payment processing module 335 may interact with one or more electronic payment services to exchange funds associated with an order. Each of these components may be in communication with one another (e.g., via one or more buses).

Application server 205-a and/or at least some of its various sub-components may be implemented in hardware, software executed by a processor, firmware, or any combination thereof. If implemented in software executed by a processor, the functions of the application server 205-a and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The application server 205-a and/or at least some of its various sub-components may be physically located at various positions, including being distributed such that portions of functions are implemented at different physical locations by one or more physical devices. In some examples, application server 205-a and/or at least some of its various sub-components may be a separate and distinct component in accordance with various aspects of the present disclosure. In other examples, application server 205-a and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

One or more processors of the application server 205-a may include an intelligent hardware device, (e.g., a general-purpose processor, a central processing unit (CPU), a microcontroller, an ASIC, an FPGA, a programmable logic device, a discrete gate or transistor logic component, a discrete hardware component, or any combination thereof). Such processors may be configured to execute computer-readable instructions stored in a memory to perform various functions (e.g., functions or tasks supporting in-restaurant ordering).

Memory 330 may include random access memory (RAM) and read only memory (ROM). The memory 330 may store computer-readable, computer-executable software 340 including instructions that, when executed, cause the processor to perform various functions described herein. In some cases, the memory 330 may contain, among other things, a basic input/output system (BIOS) which may control basic hardware or software operation such as the interaction with peripheral components or devices. Memory 330 may be a single memory component or distributed across two or more components that include memory.

Software 340 may include code to implement aspects of the present disclosure, including code to support restaurant ordering as discussed herein. Software 340 may be stored in a non-transitory computer-readable medium such as system memory or other memory. In some cases, the software 340 may not be directly executable by the processor but may cause a computer (e.g., when compiled and executed) to perform functions described herein.

The various illustrative blocks and modules described in connection with the disclosure herein may be implemented or performed with a general-purpose processor, an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

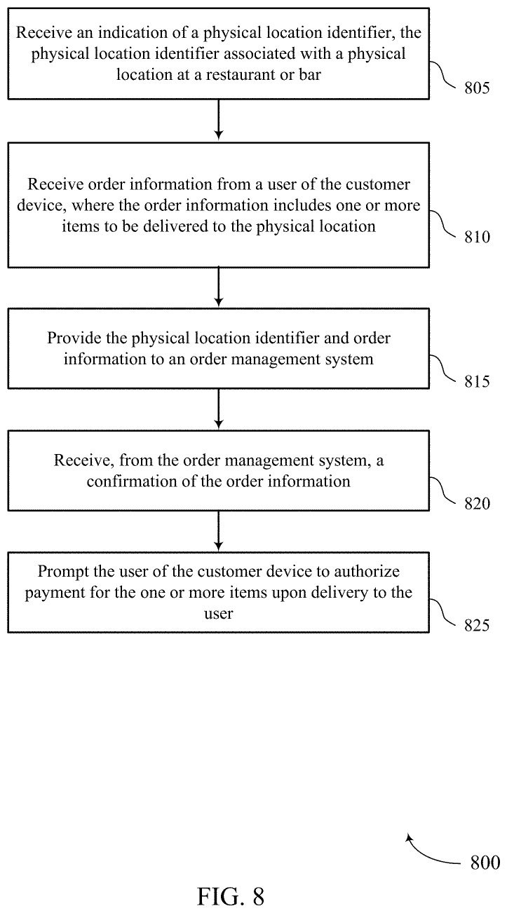

FIG. 8 shows a flowchart illustrating a method 800 that supports techniques for order management in accordance with aspects of the present disclosure. The operations of the method 800 may be implemented by an application at a user device or a web interface/application server that is accessed by the user device. In some examples, a user device or application server may execute a set of instructions to control the functional elements of the device to perform the described functions.

At 805, the method may include receiving an indication of a physical location identifier, the physical location identifier associated with a physical location at a restaurant or bar. The operations of 805 may be performed in accordance with examples as disclosed herein. In some examples, aspects of the operations of 805 may be performed by a location identification module 310 as described with reference to FIG. 3.

At 810, the method may include receiving order information from a user of the customer device, where the order information includes one or more items to be delivered to the physical location. The operations of 810 may be performed in accordance with examples as disclosed herein. In some examples, aspects of the operations of 810 may be performed by a menu management module 320 as described with reference to FIG. 3.

At 815, the method may include providing the physical location identifier and order information to an order management system. The operations of 815 may be performed in accordance with examples as disclosed herein. In some examples, aspects of the operations of 815 may be performed by an order processing module 325 and network interface 305 as described with reference to FIG. 3.

At 820, the method may include receiving, from the order management system, a confirmation of the order information. The operations of 820 may be performed in accordance with examples as disclosed herein. In some examples, aspects of the operations of 820 may be performed by the order processing module 325 and network interface 305 as described with reference to FIG. 3.

At 825, the method may include prompting the user of the customer device to authorize payment for the one or more items upon delivery to the user. The operations of 825 may be performed in accordance with examples as disclosed herein. In some examples, aspects of the operations of 825 may be performed by a payment processing module 335 as described with reference to FIG. 3.

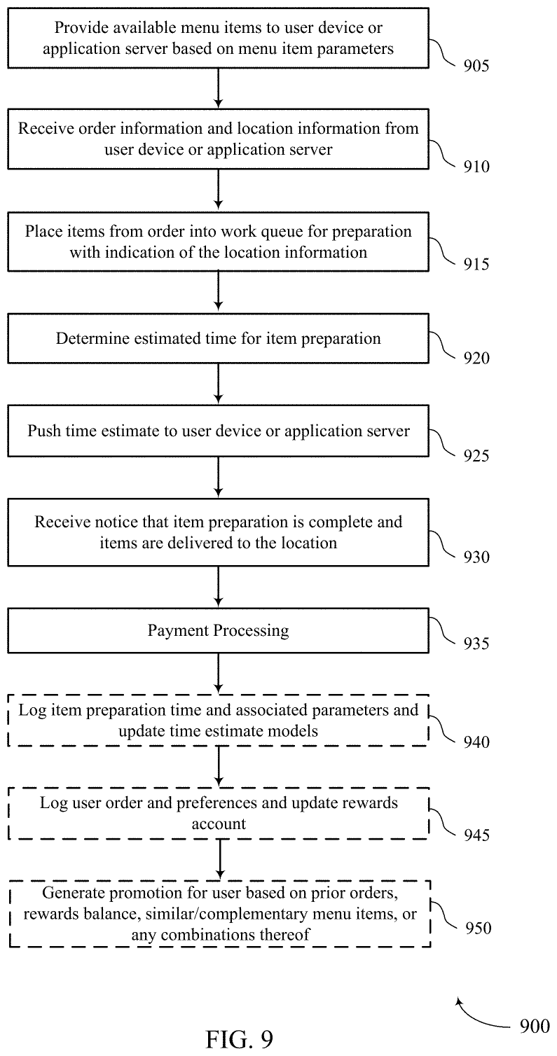

FIG. 9 shows a flowchart illustrating a method 900 that supports techniques for order management in accordance with aspects of the present disclosure. The operations of the method 900 may be implemented by an application at a user device or a web interface/application server that is accessed by the user device, in conjunction with an order management system. In some examples, a user device, application server, and/or order management system may execute a set of instructions to control the functional elements of the device to perform the described functions.

At 905, the method may include providing available menu items to user device or application server based on menu item parameters. The operations of 905 may be performed in accordance with examples as disclosed herein. In some examples, aspects of the operations of 905 may be performed by a menu management module 320 as described with reference to FIG. 3. In some cases, the available menu items may be provided based on one or more parameters associated with a user that is accessing the menu (e.g., as determined based on user credentials provided to access the menu on the user device). For example, menu items may be displayed based on an age of the user, user allergen information, user preferences (e.g., vegetarian or vegan preferences), or any combinations thereof. In some cases, additionally or alternatively, the available menu items may be provided based on a time of day (e.g., lunch versus dinner menu), a day of the week, whether the order is dine-in, take out, or delivery, availability of items at the restaurant or current specials at the restaurant, or any combinations thereof.

At 910, the method may include receiving order information and location information from user device or application server. The operations of 910 may be performed in accordance with examples as disclosed herein. In some examples, aspects of the operations of 910 may be performed by a menu management module 320 as described with reference to FIG. 3.

At 915, the method may include placing items from the order into a work queue for preparation with the indication of the location information. The operations of 915 may be performed in accordance with examples as disclosed herein. In some examples, aspects of the operations of 915 may be performed by an order processing module 325 and network interface 305 as described with reference to FIG. 3.

At 920, the method may include determining an estimated time for item preparation. The operations of 920 may be performed in accordance with examples as disclosed herein. In some examples, aspects of the operations of 920 may be performed by the order processing module 325 or order management system 140 as described with reference to FIGS. 1-3. The determination of the time estimate may be based on a number of factors, as discussed herein, and in some cases a machine learning algorithm may determine time estimates based on logged information related to past timing for item preparation, staffing levels, personnel that are working, equipment status, other items that are ahead in a work queue, or any combinations thereof.

At 925, the method may include pushing the time estimate to the user device or application server. The operations of 925 may be performed in accordance with examples as disclosed herein. In some examples, aspects of the operations of 925 may be performed by the order processing module 325 or order management system 140 as described with reference to FIGS. 1-3.

At 930, the method may include receiving a notice that item preparation is complete and items are delivered to the location. The operations of 930 may be performed in accordance with examples as disclosed herein. In some examples, aspects of the operations of 930 may be performed by the order processing module 325 or order management system 140 as described with reference to FIGS. 1-3.

At 935, the method may include processing payment for the items. The operations of 935 may be performed in accordance with examples as disclosed herein. In some examples, aspects of the operations of 935 may be performed by payment processing module 335 as described with reference to FIGS. 1-3. In some cases, payment processing may include aggregating items from multiple users in a party for payment. In some cases, two or more members of a party may split a tab, and payment processing may be based thereon. Further, in some cases two or more users in a party may select to have a random determination of the user that is to pay, or may select to have a winner of a game determine the user that is to pay.

Optionally, at 940, the method may include logging item preparation time and associated parameters and updating time estimate models. Further, at 945, the method may optionally include logging user order and preferences and update a rewards account of the user. Additionally, at 950, the method may optionally include generating a promotion for the user based on prior orders, rewards balance, similar/complementary menu items, or any combinations thereof. The operations of 940 through 950 may be performed in accordance with examples as disclosed herein. In some examples, aspects of the operations of 940 through 950 may be performed by the order processing module 325 or order management system 140 as described with reference to FIGS. 1-3.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A food ordering system, comprising:
an application server configured to receive order information and a physical location identifier from a user via an application running at user mobile device or a web interface accessed via the user mobile device, wherein the order information includes one or more items to be delivered to the user and the physical location identifier is associated with a physical location within a dining area of a food service establishment;
an order management system coupled with the application server and configured to receive order information and the physical location identifier and provide the order information to a kitchen or service area for production; and
a payment component coupled with the order management system and the application server and configured to electronically process payment for the one or more items after delivery to the user.

2. The food ordering system of claim 1, wherein:
the physical location identifier comprises one or more of a table number that is marked on a table and entered into the mobile device by the user, an identification from an optical marker on the table that is scanned into the mobile device, an electronic identification based on an electronic marker on the table that read by the mobile device, or any combinations thereof.

3. The food ordering system of claim 1, wherein:
the order management system is further configured to perform metering of received orders based on a rate of production of the kitchen or service area, and to provide a time estimate to the user for delivery of the one or more items based at least in part on the rate of production.

4. The food ordering system of claim 3, wherein:
the rate of production is determined based at least in part on one or more of a historical rate of production for the one or more items, a number of staff that are available for producing the one or more items, one or more particular staff members working in the kitchen or service area, or any combinations thereof.

5. The food ordering system of claim 1, wherein:
the order management system is further configured to receive input indicating that the one or more items have been delivered to the user and to initiate payment processing responsive to the received input.

6. The food ordering system of claim 1, wherein:
the application server is further configured to provide menu information to the mobile device, wherein the menu information is determined based at least in part on one or more of a list of available items, a restaurant site of the physical location, a time of day, an age of the user, or any combinations thereof.

7. The food ordering system of claim 1, wherein:
the application server is further configured to provide menu information to the mobile device, wherein the menu information is determined based at least in part on allergen information provided by the user.

8. The food ordering system of claim 1, wherein:
the application server is further configured to receive a request from the user to be added to a wait list for a table and provide the request to the order management system; and
the order management system is further configured to place the user into a queue for an available table, provide an estimated wait time to the application server, and provide a notification to the application server when a table is available for the user.

9. The food ordering system of claim 8, wherein:
the order information is received prior to the table being available for the user, and wherein the order management system provides the order information to the kitchen or service area for production based on a projected preparation time of the order and the estimated wait time to provide delivery of the order within a predetermined period after the estimated wait time.

10. A method for restaurant or bar order management at a customer device, comprising:
receiving an indication of a physical location identifier at an application running at the customer device, the physical location identifier associated with a physical location at a restaurant or bar;
receiving order information from a user of the customer device via the application, wherein the order information includes one or more items to be delivered to the physical location;
providing the physical location identifier and order information to an order management system;
receiving, from the order management system, a confirmation of the order information; and
prompting the user of the customer device to authorize payment for the one or more items upon delivery to the user.

11. The method of claim 10, wherein:
the physical location identifier comprises one or more of a table number that is marked on a table and entered into the customer device by the user, an identification from an optical marker on the table that is scanned into the customer device, an electronic identification based on an electronic marker on the table that read by the customer device, or any combinations thereof.

12. The method of claim 10, further comprising:
receiving, from the order management system, a time estimate for delivery of the one or more items.

13. The method of claim 10, further comprising:
receiving, from the order management system, menu information that indicates available items for order by the user.

14. The method of claim 13, further comprising:
receiving, from the user, one or more of age information, allergen information, or combinations thereof, and wherein the available items for order by the user are based at least in part on the age information, the allergen information, or any combinations thereof.

15. The method of claim 13, wherein:
the available items for order by the user are based at least in part on a list of available items, a restaurant site of the physical location, a time of day, a to-go or dine-in order type, or any combinations thereof.

16. The method of claim 10, further comprising:
receiving, from the user, a request to be added to a wait list for a table; and
receiving, from the order management system, an estimated wait time for an available table;
receiving, from the order management system, a notification that a table is available for the user; and
providing a notice to the user responsive to the notification that the table is available.

17. The method of claim 16, wherein:
the order information is received from the user and provided to the order management system prior to the receiving the notification that the table is available.

18. The method of claim 10, further comprising:
receiving, from a different application at a different customer device, a request to join a party of the user; and
authorizing, with the order management system responsive to an approval provided by the user, the different application at the different customer device to join the party of the user, and wherein items ordered through the different application at the different customer device are added to a tab associated with the party of the user.

19. The method of claim 18, further comprising:
prompting the user with a plurality of payment options for the tab, wherein the plurality of payment options include one or more of a splitting option to divide the tab between two or more users that agree to split the tab, a random selection option to randomly select one of two or more users to pay the tab, or an exclusion option that excludes one or more users and splits the tab between remaining users.

20. The method of claim 10, further comprising:
receiving, from the user, a selection of a plurality of items and a timing for delivery of each of the plurality of items; and
providing the selection and the timing to the order management system.
